(19) United States
(12) Patent Application Publication
(10) Pub. No.: US 2022/0333993 A1
(43) Pub. Date: Oct. 20, 2022

(54) Modulation Device for Periodically Modulating Light

(71) Applicant: TRINAMIX GMBH, Ludwigshafen am Rhein (DE)

(72) Inventors: Sebastian VALOUCH, Cincinnati, OH (US); Robert SEND, Karlsruhe (DE)

(21) Appl. No.: 17/754,222

(22) PCT Filed: Oct. 1, 2020
(86) PCT No.: PCT/EP2020/077442

§ 371 Date: Mar. 28, 2022

(30) Foreign Application Priority Data
Oct. 2, 2019 (EP) 19201009.8

(51) Int. Cl. G01J 5/0805; G01J 3/02; G01J 3/10

(52) U.S. Cl. CPC G01J 5/0805; G01J 3/0232; G01J 3/108

(57) ABSTRACT

Described herein is a modulation device for periodically modulating light emitted by a light source. The modulation device includes at least one enclosing tube being rotatable about a cylinder axis of the enclosing tube. The enclosing tube includes at least one aperture disposed within a cylindrical wall of the enclosing tube. The modulation device further includes at least one driving system for rotating the enclosing tube about the cylinder axis. Also described herein are a modulated illumination device and a spectrometer device.

### TECHNICAL FIELD

The invention relates to a method and a modulation device for periodically modulating light emitted by a light source, a modulated illumination device, a spectrometer device and a use of the spectrometer device. Such devices and methods can, in general, be employed e.g. for investigation or monitoring purposes, in particular, in the infrared (IR) spectral region, especially in the near-infrared (NIR) and the mid-infrared (MidIR) spectral regions, and for a detection of heat, flames, fire, or smoke. However, further kinds of applications are possible.

### BACKGROUND ART

Various spectrometer devices and systems for investigations in the infrared (IR) spectral region, especially in the near-infrared (NIR) spectral region, are known. The spectrometer devices and systems generally comprise one or more wavelength-selective elements for separating incident light into a spectrum of constituent wavelengths and one or more detected devices for detecting the constituent wavelengths, such as one or more prisms, gratings, filters or the like. Especially, spectrometer devices which comprise a combination of a linearly variable filter (LVF) and a detector array have already been proposed. Herein, the LVF is designated for separating light captured from an object, also referred to as a sample, into a spectrum of constituent wavelength signals while the detector array includes a plurality of pixels, wherein each of the plurality of pixels is disposed to receive at least a portion of a plurality of the constituent wavelength signals that provides a power reading for each constituent wavelength. Typically, in order to accomplish that the incident light may impinge the LVF in a manner normal to a receiving surface of the LVF, a baffle is used for this purpose, which, however, generally results in a low light throughput and a poor signal-to-noise ratio.

For applications in the field, portable spectrometer devices have been developed. Thus, as one of the various examples, US 2014/131578 A1 discloses a portable spectrometer device which includes a light source for directing at a sample as well as a tapered light pipe (TLP) for capturing the light which interacts with the sample at a first focal ratio and for delivering the light at a second focal ratio lower than the first focal ratio to the LVF.

Specifically in the field of spectrometry and, more specifically, in the field of infrared spectrometry, providing adequate light sources remains a challenge. Thus, as an example, despite the availability of other light sources, many infrared spectrometers still make use of incandescent lamps for sample illumination. This is mainly due to the spectral properties of incandescent lamps, such as the broad emission properties of infrared light. Still, methods of spectrometry often rely on a controlled modulation of the light source. As an example, lock-in amplification principles are known for spectrometric purposes. Specifically in the infrared spectral range, however, the modulation of incandescent lamps is typically difficult. This is mainly due to the fact that, generally, the high-frequency modulation of incandescent lamps by modulating the driving currents is difficult, mainly due to the thermal nature of emission.

Therefore, in infrared spectrometry as well as in other spectral ranges and for other applications, shutter wheels, also referred to as “optical choppers” are known. As an example, optical choppers systems are commercially available for laboratory purposes, such as the MC2000B optical choppers system available by Thorlabs Elliptec GmbH, Dortmund, Germany. For spectrometric purposes, US 2005/0229698 A1 discloses a hand-held portable modular spectrometer unit. The unit includes a detachable head containing a light source and optical components for detecting spectral information from light reflected from or transmitted through a target and a processor for converting the detected spectral information into digital information. The portable modular spectrometer unit further may comprise an optical chopper.

Shutter wheels typically comprise a rotating wheel with transparent and intransparent segments in the beam path. However, the use of shutter wheels often implies several drawbacks. Thus, generally, the design of shutter wheels may be challenging, specifically in case the shutter wheel is intended to be implemented into hand-held devices such as hand-held spectrometers. Further, shutter wheels are often placed in a position separated from the light source, thereby enlarging the aperture. Further, microscopic motors used in shutter wheels are often prone to failure, specifically under long-term mechanical stress. Finally, the optical path length is typically increased significantly by the shutter wheel.

U.S. Pat. No. 3,394,253 A describes a detecting instrument, especially for infrared absorption analysis of small gas samples. The sample is introduced into a cylindrical enclosure with a smooth reflecting inner surface, and the analyzing radiation is introduced into the enclosure so as to cause it to multiply reflect along the inner surface while following a helical path until detected. A preferred arrangement provides the radiation source and detector inside the enclosure in the vicinity of its axis.

EP 0 732 580 A2 describes a gas sample identification apparatus transmit-ting at least one beam of light of predefined frequency band through a gas sample present in a gas sampling chamber. The presence and concentration of various agents in the gas sample are determined by a linear variable filter that selectively passes the light beam transmitted through the gas sample chamber to an array of detectors. The detectors are positioned to receive only a narrow passband component of the light beam. The output signals from the array of detectors is processed by a multivariate statistical processor to accurately identify both the presence and concentration of one or more agents contained in the gas sample.

U.S. Pat. No. 4,448,529 A describes spectral analysis of a beam of radiation carried out by splitting the beam of radiation into its respective spectral components and by applying a characteristic modulation to each of the spectral components before allowing them to fall on a common detector. The superimposed signals generated by the detector and representative of the spectral components are then electronically segregated by reference to the characteristic modulations that have been applied to the individual spectral components. This is conveniently done by generating a series of modulated reference signals which have been modulated in exactly the same way as the spectral components of interest. The technique is not restricted to optical spectra but can also be used, for example, for X-ray spectra and mass spectra.

GB 814 072 A describes an electrical apparatus. including a radiation source, means for directing radiation alternately along first and second paths to a radiation responsive device and means for controlling the response of said device to radiation received over one of said paths in dependence upon its response to radiation received over the other of said paths.

U.S. Pat. No. 5,818,049 A describes a respiratory gas monitor for measuring the concentration of certain gases in a respiratory gas stream having a compact and unitary lid assembly having an integral low-profile motor and a cylindrical infrared light beam chopper. The lid assembly also contains a motor position sensor and flex circuit for passing electrical signals through epoxy sealed orifices in the lid to a processing and control unit in the monitor. The flexible circuit uses releasable connectors to facilitate removal of the monitor from an external controller and the removal of the lid assembly from the bottom portion of the monitor.

U.S. Pat. No. 3,417,253 A describes a small compact pulse generating device adapted for driving coupling relation to a driven shaft is shown wherein the device includes an annular-shaped member having at least one aperture extending between its inner and outer sides and the member is adapted, for rotation about its axis in response to the rotations of the driven shaft. The member is located with a housing which supports a light source on one side of the member and a translucent epoxy resin encapsulated transistor on the other side of the member such that when the aperture is radially aligned between the light source and the encapsulated transistor, light energy from the light source impinges upon the base of the transistor whereby application of a potential across the collector and emitter of the transistor results in an abrupt change in the transistor's conductive characteristics in response to the absence and presence of light impinging upon the transistor base.

### Problem to be Solved

It is therefore desirable to provide devices and methods which address the above-mentioned challenges and shortcomings of known light sources. Specifically, devices and methods shall be proposed which are suitable for high-frequency modulation of the light, specifically infrared light, in an efficient and reliable manner, at high flexibility and in a compact fashion, even under rough environmental conditions.

### SUMMARY

This problem is addressed by a method and a modulation device for periodically modulating light emitted by a light source, a modulated illumination device, a spectrometer device and a use of the spectrometer device, with the features of the independent claims. Advantageous embodiments which might be realized in an isolated fashion or in any arbitrary combinations are listed in the dependent claims.

As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Further, as used in the following, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

In a first aspect of the present invention, a modulation device for periodically modulating light emitted by a light source is proposed. The modulation device comprises at least one enclosing tube being rotatable about a cylinder axis of the enclosing tube. The enclosing tube has at least one aperture disposed within a cylindrical wall of the enclosing tube. The modulation device further comprises at least one driving system for rotating the enclosing tube about the cylinder axis.

The term “modulation device” is a broad term and is to be given its ordinary and customary meaning to a person of ordinary skill in the art and is not to be limited to a special or customized meaning. The term specifically may refer, without limitation, to a device configured for modulating the light. Therein, the term “modulating” also is a broad term and is to be given its ordinary and customary meaning to a person of ordinary skill in the art and is not limited to a special or customized meaning. The term specifically may refer, without limitation, to the process of changing, specifically periodically changing, at least one property of the light, specifically one or both of an intensity or a phase of the light. The modulation may be a full modulation from a maximum value to zero, or may be a partial modulation, from a maximum value to an intermediate value greater than zero.

The term “light” is a broad term and is to be given its ordinary and customary meaning to a person of ordinary skill in the art and is not to be limited to a special or customized meaning. The term specifically may refer, without limitation, to electromagnetic radiation in the wavelength range of 10 nm to 1 mm. Therein, the spectral range of 380 nm to 760 nm may be referred to as the visible spectral range, wherein the wavelength range of light having wavelengths below this visible spectral range may be referred to as the ultraviolet spectral range, and wherein the wavelength range of light having wavelengths above the visible spectral range may be referred to as infrared spectral range. Again, therein, the spectral range of 760 nm to 1.4 μm may be referred to as the near-infrared (NIR) spectral range.

The term “light source” is a broad term and is to be given its ordinary and customary meaning to a person of ordinary skill in the art and is not to be limited to a special or customized meaning. The term specifically may refer, without limitation, to a device configured for emitting light. Specifically, the light source may comprise one or more of: an incandescent lamp, a light-emitting diode, a laser, a thermal emitter.

The term “enclosing tube” is a broad term and is to be given its ordinary and customary meaning to a person of ordinary skill in the art and is not to be limited to a special or customized meaning. The term specifically may refer, without limitation, to a hollow element, such as a hollow tubular element, which fully or partially may enclose an element such as the light source. The enclosing tube specifically may be rotationally symmetric about a rotational axis or axis of rotational symmetry, in the following also referred to as the cylinder axis. Consequently, the term “cylinder axis” may generally refer to a rotational axis of the enclosing tube, notwithstanding the fact that the enclosing tube may have a hollow shape deviating from a purely cylindrical shape. The enclosing tube, as an example, may be or may comprise a hollow tube with open ends on both sides and a tube wall extending there between. The hollow inner part of the tube may extend between the openings, e.g., in a cylindrical fashion. The tube, however, may also have at least one inwardly or outwardly facing rim, brim or flange on one or both sides. The enclosing tube specifically may be or may comprise at least one dynamically balanced element, in order to avoid unbalanced masses during rotation.

The term “aperture” is a broad term and is to be given its ordinary and customary meaning to a person of ordinary skill in the art and is not to be limited to a special or customized meaning. The term specifically may refer, without limitation, to a region of an element or a device which is fully or partially transparent to light in at least one spectral range, wherein the region is fully or partially surrounded by other regions of the element which are either intransparent or less transparent to the light. As an example and as will be outlined in further detail below, the aperture may either be or may comprise at least one opening which is not filled by any material, such as a through-hole in a wall of the enclosing tube, or which is fully or partially filled by a transparent material. The aperture generally may have an arbitrary shape, such as a rectangular shape, a polygonal shape, a circular shape, an oval shape or generally a round shape. The enclosing tube may have a single aperture or may have a plurality of identical or non-identical apertures. As an example, along the circumferential line of the circular tube, a single aperture may be disposed or a plurality of two, three or more apertures, such as a plurality of equidistantially disposed apertures. The circular tube may even have several circumferential lines, the circumferential lines being axially separated, each of the circumferential lines having one or more apertures disposed thereon. Therein, between two circumferential lines, the apertures may differ, e.g. in one or more of diameter, number or shape. Thus, e.g. by axially shifting a light source within the circular tube, a specific circumferential line may be addressed, thereby selecting a specific type of apertures.

The term “driving system” is a broad term and is to be given its ordinary and customary meaning to a person of ordinary skill in the art and is not to be limited to a special or customized meaning. The term specifically may refer, without limitation, to a device or a combination of devices configured for mechanically moving or rotating at least one other device or element. As will be outlined in further detail below, the driving system specifically may be or may comprise at least one rotating driving system, such as at least one motor.

The enclosing tube may have an arbitrary cross-sectional shape, e.g. a circular shape. However, other cross-sectional shapes than circular shapes are also feasible, such as polygonal shapes. The cross-sectional shape specifically may have a rotational symmetry about the cylinder axis. A diameter or equivalent diameter of the enclosing tube, as an example, may be kept rather small. Thus, as an example, the diameter or equivalent diameter of the enclosing tube may be 1.05 to 10 times the diameter or equivalent diameter of the light source. Consequently, the modulation device may generally be kept rather compact.

By rotating the enclosing tube about the cylinder axis, the at least one aperture may be rotated along a circumferential line, specifically a circle, concentrically disposed about the cylinder axis. Thus, in case a light source is disposed within the enclosing tube, specifically on the cylinder axis of the enclosing tube, specifically at an axial position identical to an axial position of the at least one aperture, a light beam emitted from the light source to an object, e.g. radially emitted, is periodically transmitted by the aperture and, thus, is modulated. The illumination of the object by the light beam therefore is periodically modulated by the modulation device.

The enclosing tube specifically may have an open end and a closed end. Thus, the enclosing tube specifically may be cup-shaped, with an open end and a closed end. The light source, as an example, may protrude into an interior space of the enclosing tube from the open end. The driving system may be connected to the enclosing tube at the closed end, such as by coupling the driving system to the closed end of the enclosing tube. Specifically, the driving system may be coupled to the closed end by an axle disposed on the cylinder axis.

The driving system specifically may comprise at least one electrical motor. Therein, various types of electrical motors may be used. The electrical motor may be disposed on the cylinder axis of the enclosing tube or in a different arrangement, e.g. perpendicular to the cylinder axis of the enclosing tube and, e.g., connected to the axle via at least one crown wheel or other transmission means. The electrical motor specifically may be miniaturized and, as an example, may comprise a micro motor.

The modulation device may be configured for high-frequency modulation. Thus, as an example, the driving system may be configured for rotating the enclosing tube at a rotational speed of at least 10,000 rounds per second, specifically of at least 20,000 rounds per second.

The at least one aperture specifically may comprise at least one of: an opening disposed at a position spaced apart from both ends of the enclosing tube; a slot in a circumferential direction in the enclosing tube; a slot in an axial direction of the enclosing tube. Thus, various types of apertures are feasible. As outlined above, the aperture may fully or partially be filled with at least one optically transparent material, specifically transparent in one or more of the ultraviolet spectral range, the visible spectral range or the infrared spectral range. Therein, as an example, a transparency of 50-100% may be given in at least one spectral range. The transparent material, as an example, may be or may comprise one or more of an optically transparent plastic material, a glass, an inorganic transparent material such as quartz.

The enclosing tube may be made of at least one basic material. Thus, as an example, the enclosing tube may fully or partially be made of at least one optically intransparent material. The at least one aperture may fully or partially be surrounded by the optically intransparent or opaque material. As an example, the optically intransparent material may be or may comprise at least one material selected from the group consisting of: a metal, such as aluminum or steel; a plastic material; a paper or cardboard material; a ceramic material.

The enclosing tube specifically may have a reflective coating on its inside. Thus, as an example, an inner wall, specifically a cylindrical inner wall, of the enclosing tube may fully or partially be coated with a reflective material, such as an inorganic or organic reflective material. As an example, the reflective coating may fully or partially be made of gold. Still, other reflective coatings are possible, such as dispersive coatings.

The at least one aperture may have a fixed size and shape. Still, the aperture may also be adjustable, either manually or automatically. The term “adjustable” is a broad term and is to be given its ordinary and customary meaning to a person of ordinary skill in the art and is not to be limited to a special or customized meaning. The term specifically may refer, without limitation, to the property of the aperture of being variable in at least one of size, shape, length or position. Thus, as an example, the size of the aperture in at least one dimension, e.g. in an axial direction and/or in a circumferential direction, may be varied. By varying the size of the aperture, such as a diameter and/or an equivalent diameter, a pulse width modulation and/or an on-off-ratio of light pulses may be adjusted. Additionally or alternatively, a shape of the aperture may be varied, such as by varying the shape from a round shape to a rectangular shape or vice versa. Again, additionally or alternatively, the position of the aperture may be varied, e.g. by shifting the aperture in one or both of an axial direction or a circumferential direction.

The adjustment of the at least one aperture may take place by various means. As an example which may be implemented in a simple mechanical fashion, the enclosing tube may comprise at least one movable segment for adjusting the aperture. Thus, as an example, by moving a ring-shaped segment having the aperture therein in an axial direction, the axial position of the aperture may be adjusted. Further, in case two or more borders of the aperture are provided by different segments which are movable with respect to one another, a movement of at least one of these segments may be used for adjusting the size and/or length of the aperture in at least one dimension and/or for adjusting the shape of the aperture. As an example, the enclosing tube may comprise at least two concentric partial tubes, each partial tube having at least one partial aperture, wherein the aperture of the enclosing tube may be adjustable by one or both of turning or shifting the tubes relative to one another. Other means of adjusting the aperture are feasible.

In a further aspect of the present invention, a modulated illumination device is disclosed. The term “illumination device” is a broad term and is to be given its ordinary and customary meaning to a person of ordinary skill in the art and is not to be limited to a special or customized meaning. The term specifically may refer, without limitation, to a device configured for illuminating at least one object with light in one or more of the above-mentioned spectral ranges. Specifically, as outlined above, the modulated illumination device may be an illumination device configured for emitting light in the infrared spectral range, specifically in the near infrared spectral range.

The modulated illumination device comprises at least one modulation device according to the present invention, such as according to any one of the embodiments disclosed above and/or according to any one of the embodiments disclosed in further detail below. The modulated illumination device further comprises at least one light source disposed at least partially within the enclosing tube of the modulation device. Thus, the light source is fully or partially enclosed by the enclosing tube of the modulation device. Still, preferably, a contact between the light source and the enclosing tube, specifically an inner wall of the enclosing tube, is avoided. The at least one aperture and the light source preferably are located at essentially the same axial position with respect to the cylinder axis of the enclosing tube, wherein tolerances are feasible, such as tolerances leading to an angular displacement of 30° or less. An object also disposed essentially at the same axial position with respect to the cylinder axis, thus, is illuminated with light from the light source in an intermittent fashion, wherein the illumination takes place whenever the enclosing tube is in a rotational position such that the light source, the aperture and the object are in line, and wherein the illumination is switched off whenever this condition is not fulfilled. Thereby, a modulated illumination may be provided.

The light source specifically may be a continuously emitting light source. Thus, a modulation of the light source itself is generally not necessary, even though this modulation is still possible.

The modulation of the light source typically may take place, as outlined above, by modulating a driving current of the light source which, specifically, is challenging in case the light source is or comprises an incandescent lamp. Thus, specifically, the light source may comprise an incandescent lamp. Specifically, the incandescent lamp may be driven continuously, such as with a constant driving current.

In a further aspect of the present invention, a spectrometer device for optical analysis of at least one sample is disclosed. The term “spectrometer device” is a broad term and is to be given its ordinary and customary meaning to a person of ordinary skill in the art and is not to be limited to a special or customized meaning. The term specifically may refer, without limitation, to a device capable of optically analyzing at least one sample, thereby generating at least one item of information on at least one spectral property of the sample. Specifically, the term may refer to a device which is capable of recording the signal intensity with respect to the corresponding wavelength of a spectrum or a partition thereof, such as a wavelength interval, wherein the signal intensity may, preferably, be provided as an electrical signal which may be used for further evaluation.

The term “analyzing” or the term “analysis” are broad terms and are to be given their ordinary and customary meaning to a person of ordinary skill in the art and are not to be limited to a special or customized meaning. The terms specifically may refer, without limitation, to the process of deriving at least one item of information on a property of a sample. Consequently, the terms “optically analyzing” or “optical analysis” refer to the process of analyzing or an analysis by using optical means, such as spectroscopic means. Specifically, the spectrometer device may be configured for deriving at least one item of information on at least one spectral property of the sample. As an example, the spectrometer device may be configured for deriving at least one item of spectral information on the sample, such as at least one distribution of intensities over a spectral range for a reflection spectrum and/or for a transmission spectrum. Other examples, however, are possible. The hand-held spectrometer device specifically may be configured for providing at least one item of electronic information, such as an analogue and/or digital signal, representative for the at least one item of spectral information.

The term “sample” is a broad term and is to be given its ordinary and customary meaning to a person of ordinary skill in the art and is not to be limited to a special or customized meaning. The term specifically may refer, without limitation, to an arbitrary amount of material, an element or a device to be analyzed. Specifically, the sample may be an amount of amorphous material, such as an amount of one or more of liquid, powder, pellets, particles or gas. Specific examples of samples will be given in further detail below.

The spectrometer device comprises at least one wavelength-selective element configured for separating incident light into a spectrum of constituent wavelengths. The term “wavelength-selective element” is a broad term and is to be given its ordinary and customary meaning to a person of ordinary skill in the art and is not to be limited to a special or customized meaning. The term specifically may refer, without limitation, to an arbitrary element or a combination of elements suitable for one or more of transmitting, reflecting, deflecting or scattering light in a wavelength-dependent manner. The wavelength-selective element, as an example, may be or may comprise at least one element selected from the group consisting of: an optical grating; an optical prism; a wavelength-selective optical filter, specifically a length variable filter.

The spectrometer device further comprises at least one detector device configured for detecting at least a portion of the constituent wavelengths. The term “detector device” is a broad term and is to be given its ordinary and customary meaning to a person of ordinary skill in the art and is not to be limited to a special or customized meaning. The term specifically may refer, without limitation, to an arbitrary device or combination of devices capable of monitoring and/or recording at least one physical, chemical or biological parameter. Specifically, the detector device may comprise at least one optical detector device, such as a device configured for recording and/or monitoring incident light. The detector device specifically may, thus, be or may comprise an optical detector element, such as at least one optical sensor, e.g. an optical semiconductor sensor. As an example, the detector device may comprise at least one array of photosensitive elements. As an example, the detector device may comprise at least one photodetector such as at least one CCD or CMOS device. The detector device specifically may comprise at least one detector array comprising a plurality of pixelated sensors, wherein each of the pixelated sensors is configured to detect at least a portion of at least one of the constituent wavelengths.

The spectrometer device further comprises at least one modulated illumination device according to the present invention, such as according to any one of the embodiments disclosed above and/or according to any one of the embodiments disclosed in further detail below. The at least one modulated illumination device specifically may be positioned such that the light generated by the modulated illumination device illuminates the sample, is reflected by the sample, wherein the reflected light, then also referred to as the incident light, is separated by the wavelength-selective element into the spectrum of constituent wavelengths and, subsequently, at least a portion of the constituent wavelengths is detected by the detector device.

Specifically, the spectrometer device may comprise at least one housing having at least one entrance window. The at least one wavelength-selective element as well as the detector device may be disposed within the housing.

The term “housing” is a broad term and is to be given its ordinary and customary meaning to a person of ordinary skill in the art and is not to be limited to a special or customized meaning. The term specifically may refer, without limitation, to an element or a combination of elements which are configured for fully or partially surrounding and/or providing mechanical cover for one or more other elements. Thus, as an example, the housing may be or may comprise at least one rigid housing, such as at least one rigid housing made of at least one of a plastic material or a metal. The rim specifically may be configured for engagement with the housing by one or more of a form-fit connection, a force-fit connection or a connection by material engagement. Thus, as an example, as will be outlined in further detail below, the rim may be or may provide one or more connection elements and/or may provide for a flexible frame and/or sealing frame which may fully or partially surround a front surface of the spectrometer device. The term “entrance window” is a broad term and is to be given its ordinary and customary meaning to a person of ordinary skill in the art and is not to be limited to a special or customized meaning. The term specifically may refer, without limitation, to an arbitrary element, such as an optically transparent element made of one or more of glass, quartz or a plastic material, or an opening of the hand-held spectrometer device allowing for the light entering the housing. Thus, as an example, the entrance window may be or may comprise an opening in the housing. The opening may be empty or may fully or partially be filled with one or more transparent elements, such as one or more transparent elements selected from the group consisting of glass elements, quartz elements or plastic elements.

The at least one modulated illumination device may fully or partially be disposed within the housing and/or may fully or partially be disposed outside the housing. The light reflected by the sample may enter the housing through the entrance window, forming the incident light.

The spectrometer device specifically may be a hand-held spectrometer device. The term “hand-held” is a broad term and is to be given its ordinary and customary meaning to a person of ordinary skill in the art and is not to be limited to a special or customized meaning. The term specifically may refer, without limitation, to the property of a device capable of being mobile and/or moved by a human user, specifically capable of being carried by a human user, specifically capable of being carried by a human user with a single hand. Specifically, the hand-held device may be dimensioned for being carried by the human user, e.g. by having extensions in any dimension not exceeding 500 mm, specifically not exceeding 400 mm. Additionally or alternatively, the hand-held device, for being carried by the human user, may have a weight not exceeding 5 kg, specifically not exceeding 3 kg or even not exceeding 1 kg.

The spectrometer device specifically may comprise at least one evaluation unit. The term “evaluation unit” is a broad term and is to be given its ordinary and customary meaning to a person of ordinary skill in the art and is not to be limited to a special or customized meaning. The term specifically may refer, without limitation, to a device or a combination of devices configured for one or both of controlling and operation of another device and/or for evaluating values such as measurement values provided by another device. Thus, as an example, the evaluation unit may be configured for controlling the operation of the spectrometer device, such as for triggering the analysis of the at least one sample and/or for configuring parameters for the analysis. Further, additionally or alternatively, the at least one evaluation unit may also be configured for evaluating at least one signal, such as at least one signal provided by the at least one detector device. Thus, as an example, the at least one evaluation unit may evaluate at least one detector signal and may generate at least one analytical information on the sample, such as at least one item of information on at least one spectroscopic property of the sample. The evaluation unit specifically may comprise at least one data processing device. Thus, as an example, the evaluation unit may comprise at least one processor which is configured, by programming, for performing one or more of a controlling operation and/or an evaluation operation, as outlined above. The evaluation unit may further comprise at least one interface for unidirectional and/or bidirectional exchange of data and/or commands with at least one other device and/or with at least one user.

The evaluation unit is configured for driving the modulation device, specifically for driving the modulated illumination device. Thus, as an example, the evaluation unit may directly or indirectly provide one or more of control commands, control data or driving current for the at least one driving system for rotating the enclosing tube about the cylinder axis and/or may provide one or more of control commands, control data or driving current for the at least one light source.

The evaluation unit may further be configured for analyzing at least one detector signal provided by the detector device in a frequency-selective manner, specifically by using a lock-in amplification. Thus, as an example, the detector signal may be frequency-mixed with a periodic driving signal corresponding to the frequency of the illumination of the sample by the modulated illumination device, and the resulting signal may be filtered, such as using a low-pass filter. Thereby, by using frequency-selective evaluation techniques for evaluating the detector signal, background signals may be reduced, and the signal-to-noise ratio may be increased.

In a further aspect of the present invention, a method for periodically modulating light emitted by a light source is proposed. The method comprises the following method steps. The method steps specifically may be performed in the given order. A different order, however, is also possible, including the option of performing one or more of the method steps fully or partially simultaneously. Further, one or more of the method steps may be performed in a repeated fashion. The method may comprise additional steps which are not listed. The method comprises the following steps:
i) providing the modulation device according to the present invention, such as according to any one of the embodiments disclosed above and/or according to any one of the embodiments disclosed in further detail below;
ii) providing at least one light source at least partially disposed within the enclosing tube of the modulation device;
iii) controlling the light source to emit light; and
iv) rotating the enclosing tube about the cylinder axis.

In a further aspect, a use of the modulation device according to the present invention, such as according to any one of the embodiments disclosed above and/or according to any one of the embodiments disclosed in further detail below, is disclosed, for a purpose of use, selected from the group consisting of: an infrared detection application; a spectroscopy application; an exhaust gas monitoring application; a combustion process monitoring application; a pollution monitoring application; an industrial process monitoring application; a chemical process monitoring application; a food processing process monitoring application; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; a food analysis application; an agricultural application such as characterization of soil, silage, feed, crop or produce, monitoring plant health; a plastics identification and/or recycling application; a heat-detection application; a thermometer application; a heat-seeking application; a flame-detection application; a fire-detection application; a smoke-detection application; a temperature sensing application.

The devices and methods according to the present invention provide a plurality of advantages over known devices and methods of similar kind. Thus, specifically, the above-mentioned technical challenges may be addressed. Specifically, a modulation device and a modulated illumination device may be provided which are both reliable and compact, even in conjunction with the use of incandescent lamps, e.g. for generating infrared light. Thus, as opposed to voluminous shutter wheels, the rotating enclosing tube may have a diameter which is larger than a diameter of the incandescent lamp but which still is small compared with typical diameters of shutter wheels. The diameter of the rotating enclosing tube may be as small as, e.g., 1.3 times or the diameter or equivalent diameter of the incandescent lamp or light source or even less. Further, due to the smaller diameter, the mechanical forces acting on the modulation device are significantly smaller than typical forces acting on shutter wheels. Consequently, the mechanical reliability and long-term stability of the rotating enclosing tube may be significantly higher than for shutter wheels. The compact design of the modulated illumination device may be used specifically for implementation into hand-held devices, such as hand-held spectrometer devices. The compact modulated illumination device may fully or partially be implemented even into the housing of the spectrometer device. The robust and compact design further is specifically suited for applications in the field, even under of environmental conditions.

The modulated illumination device, as outlined above, specifically may comprise at least one incandescent lamp. Thus, a modulation of light emitted by incandescent lamps is possible, even without the necessity for modulating a driving current of the incandescent lamp. The enclosing tube may also be referred to as a “chopper tube”. The incandescent lamp may be disposed inside the chopper tube. The enclosing tube may be rotated by a motor, such as by using a micro-mechanical motor. These motors are generally available having a high rotational speed, e.g. configured for rotating at 10.000-20.000 rounds per second. In case a single aperture is provided within the enclosing tube, this rotational speed of the motor typically corresponds to the modulation frequency of the light. In case a plurality of apertures is provided, the frequency may even be increased by a factor n, with n being an integer indicating the number of apertures along a circumferential line. Generally, these high frequencies are either not possible or at least challenging when using conventional shutter wheels. Further, by directly surrounding the incandescent lamp, such as the incandescent light bulb, with the enclosing tube and with the aperture very close to the light source, the optical path length may be rendered smaller than in a chopper wheel setup, thus rendering the overall design more compact than in a chopper wheel setup.

As outlined above, the enclosing tube may have a reflective coating on the inside. Thus, as an example, metal coatings such as a gold coating may be used. These coatings may ensure high reflectivity and little light power loss over a broad wavelength range. Thus, generally, the efficiency of the modulated illumination device may be increased as compared to conventional setups using shutter wheels.

Summarizing and without excluding further possible embodiments, the following embodiments may be envisaged:

Embodiment 1: Modulation device for periodically modulating light emitted by a light source, the modulation device having at least one enclosing tube being rotatable about a cylinder axis of the enclosing tube, the enclosing tube having at least one aperture disposed within a cylindrical wall of the enclosing tube, the modulation device further having at least one driving system for rotating the enclosing tube about the cylinder axis.

Embodiment 2: Modulation device according to the preceding embodiment, wherein the enclosing tube has an open end and a closed end, wherein the driving system is coupled to the closed end of the enclosing tube.

Embodiment 3: The modulation device according to the preceding embodiment, wherein the driving system is coupled to the closed end by an axle disposed on the cylinder axis.

Embodiment 4: The modulation device according to any one of the preceding embodiments, wherein the driving system comprises at least one electrical motor.

Embodiment 5: The modulation device according to the preceding embodiment, wherein the electrical motor comprises a micro motor.

Embodiment 6: The modulation device according to any one of the preceding embodiments, wherein the driving system is configured for rotating the enclosing tube at a rotational speed of at least 10,000 rounds per second, specifically of at least 20,000 rounds per second.

Embodiment 7: The modulation device according to any one of the preceding embodiments, wherein the at least one aperture comprises at least one of: an opening disposed at a position spaced apart from both ends of the enclosing tube; a slot in a circumferential direction in the enclosing tube; a slot in an axial direction of the enclosing tube.

Embodiment 8: The modulation device according to any one of the preceding embodiments, wherein the aperture is fully or partially filled with at least one optically transparent material, transparent in one or more of the ultraviolet spectral range, the visible spectral range or the infrared spectral range.

Embodiment 9: The modulation device according to any one of the preceding embodiments, wherein the enclosing tube is fully or partially made of at least one optically intransparent material.

Embodiment 10: The modulation device according to any one of the preceding embodiments, wherein the enclosing tube has a reflective coating on its inside.

Embodiment 11: The modulation device according to the preceding embodiment, wherein the reflective coating is fully or partially made of gold.

Embodiment 12: The modulation device according to any one of the preceding embodiments, wherein the aperture is adjustable.

Embodiment 13: The modulation device according to the preceding embodiment, wherein the enclosing tube comprises at least one movable segment for adjusting the aperture.

Embodiment 14: The modulation device according to any one of the two preceding embodiments, wherein the aperture is adjustable in at least one of size, position, width or length.

Embodiment 15: The modulation device according to any one of the three preceding embodiments, wherein the enclosing tube comprises at least two concentric partial tubes, each partial tube having at least one partial aperture, wherein the aperture of the enclosing tube is adjustable by one or both of turning or shifting the tubes relative to one another.

Embodiment 16: A modulated illumination device, comprising at least one modulation device according to any one of the preceding embodiments, further comprising at least one light source disposed at least partially within the enclosing tube of the modulation device.

Embodiment 17: The modulated illumination device according to the preceding embodiment, wherein the light source is a continuously emitting light source.

Embodiment 18: The modulated illumination device according to any one of the two preceding embodiments, wherein the light source comprises an incandescent lamp.

Embodiment 19: A spectrometer device for optical analysis of at least one sample, the spectrometer device having at least one wavelength-selective element configured for separating incident light into a spectrum of constituent wavelengths, further having at least one detector device configured for detecting at least a portion of the constituent wavelengths, and at least one modulated illumination device according to any one of the preceding embodiments referring to a modulated illumination device.

Embodiment 20: The spectrometer device according to the preceding embodiment, wherein the spectrometer device is a hand-held spectrometer device.

Embodiment 21: The spectrometer device according to any one of the two preceding embodiments, wherein the spectrometer device further has at least one evaluation unit, wherein the evaluation unit is configured for driving the modulation device and wherein the evaluation unit further is configured for analyzing at least one detector signal provided by the detector device in a frequency-selective manner, specifically by using a lock-in amplification.

Embodiment 22: A method for periodically modulating light emitted by a light source, the method comprising:

i) providing the modulation device according to any one of the preceding embodiments referring to a modulation device;

ii) providing at least one light source at least partially disposed within the enclosing tube of the modulation device;

iii) controlling the light source to emit light; and

iv) rotating the enclosing tube about the cylinder axis.

Embodiment 23: A use of the modulation device according to any one of the preceding embodiments referring to a modulation device, for a purpose of use, selected from the group consisting of: an infrared detection application; a spectroscopy application; an exhaust gas monitoring application; a combustion process monitoring application; a pollution monitoring application; an industrial process monitoring application; a chemical process monitoring application; a food processing process monitoring application; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; a food analysis application; an agricultural application such as characterization of soil, silage, feed, crop or produce, monitoring plant health; a plastics identification and/or recycling application; a heat-detection application; a thermometer application; a heat-seeking application; a flame-detection application; a fire-detection application; a smoke-detection application; a temperature sensing application.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiment. The embodiments are schematically depicted in the Figures.

In the Figures:

FIGS. 1A to 1C show various views of an embodiment of a modulation device and of a modulated illumination device; and

FIG. 2 shows a schematic view of an embodiment of a spectrometer device.

### DETAILED DESCRIPTION OF THE EMBODIMENTS

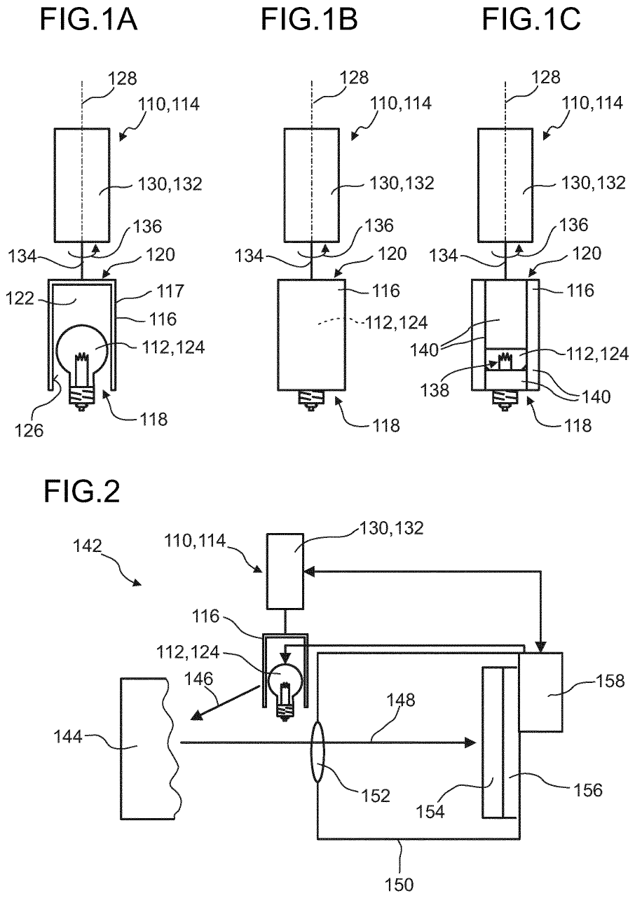

In FIGS. 1A to 1C, various views of an embodiment of a modulation device 110 for periodically modulating light emitted by a light source 112 as well as of a modulated illumination device 114 are shown. Therein, FIG. 1A shows a cross-sectional view through the modulation device 110, the light source 112 and the modulation illumination device 114, FIG. 1B shows a front view with the modulation device 110 in a closed position, and FIG. 1C shows a front view with the modulation device 110 in an open position. These figures, in the following, will be explained in conjunction.

The modulation device 110 comprises a enclosing tube 116, having an open end 118 as well as, optionally, a closed end 120. The enclosing tube 116 has a cylindrical wall 117. The light source 112, from the open end 118, protrudes into an inner space 122 of the enclosing tube 116. As an example and as depicted in FIG. 1A, the light source 112 may comprise an incandescent lamp 124. An inner wall 126 of the enclosing tube 116 may be coated with at least one reflective coating, such as a gold coating. The enclosing tube 116, as an example, may be made of a metallic material, such as aluminum.

The enclosing tube is rotatable about a cylinder axis 128 of the enclosing tube 116. The modulation device 110 comprises at least one driving system 130 for rotating the enclosing tube 116 about the cylinder axis 128. Thus, as an example, the driving system 130 may comprise at least one motor 132, such as at least one micro-mechanical motor. The driving system 130 may be connected to the closed end 120 of the enclosing tube 116, e.g. by at least one axle 134. A rotation, in FIGS. 1A to 1C, is symbolically depicted by reference number 136.

The enclosing tube 116 comprises at least one aperture 138, as can be seen in FIG. 1C. The aperture 138 may be disposed at the same axial position along the cylinder axis 128 as the light source 112, such that light emitted by the light source 112 in a radial direction may pass through the aperture 138. In a direction of view, e.g. in the front view shown in FIG. 1C, when the enclosing tube 116 rotates, the light beam emitted radially by the light source 112 through the aperture 118 is intermittently interrupted by the closed parts of the enclosing tube 116. Consequently, the light beam is modulated, with the rotational frequency of the rotation 136 or, in case a plurality of apertures 138 is provided, with a multiple of this rotational frequency. The enclosing tube 116 may be made of an intransparent material, and the aperture 138 may either be made of an empty opening in the enclosing tube 116 or by a transparent part of the enclosing tube 116. Thus, the aperture 138 may be left open or may fully or partially be filled with at least one optically transparent material.

The at least one aperture 138 may be fixed in size, shape and position. Still, however, the aperture 138 may also be adjustable in at least one of size, position, width or length, wherein the width, as an example, is measured along a circumferential line across the aperture 138, and wherein the length, as an example, may be defined as the extension along the cylinder axis 128. For adjustment of the aperture 138, various possibilities are given. Thus, as an example, the enclosing tube 116 may comprise one or more movable segments 140. As an example, these movable segments 140 may be concentric tubular segments of the enclosing tube 116. By changing the relative position of these movable segments 140, the aperture 138 may be adjusted.

In FIG. 2, a schematic view of an exemplary embodiment of a spectrometer device 142 for optical analysis of at least one sample 144 is shown in a cross-sectional view. The spectrometer device 142 comprises the modulation device 110 and the modulated illumination device 114 according to the embodiment shown in FIGS. 1A to 1C. Thus, for details of these elements, reference may be made to the description of FIGS. 1A to 1C above. Still, other embodiments are feasible, too. The modulated illumination device 114 is configured for illuminating the sample 144 with light 146.

Light 148 reflected by the sample 144, also denoted as incident light, enters a housing 150 of the spectrometer device 142 through an entrance window 152. Within the housing 150, a wavelength-selective element 154 is disposed, for separating incident light into a spectrum of constituent wavelengths. The spectrometer device 142 further comprises at least one detector device 156 for detecting at least a portion of the constituent wavelengths.

The spectrometer device 142 may further comprise at least one evaluation unit 158 which may be configured for analyzing at least one detector signal provided by the detector device 156. The evaluation unit 158, which may be a central evaluation unit 158 or a decentralized evaluation unit 158, may further be connected to one or more of the light source 112 and/or the driving system 130, and, as an example, may be configured for controlling one or both of these devices. Thus, as an example, the evaluation unit 158 may make use of the modulation device 110 for a frequency-selected analysis of the sample 144, e.g. by using a lock-in amplification principle. Thus, frequency-selective analysis of at least one sample 144 may be performed even when an incandescent lamp 124 is used as a light source 112, which typically is challenging specifically at high frequencies, since a modulation of the driving current of incandescent lamps 124 typically is rather difficult at high frequencies. Consequently, the setup shown in FIG. 2, as an example, may provide for the possibility of infrared spectroscopic analysis of the sample 144 in a high-frequency modulation setup, thereby being capable of providing a high signal-to-noise ratio. Still, as compared to conventional chopper wheels, the setup using the modulation device 110 with the enclosing tube 116 may be rendered rather compact and robust, such that the spectrometer device 142 may also be configured as a hand-held spectrometer device 142 which is capable of performing analysis even under rough environmental conditions in the field.

### LIST OF REFERENCE NUMBERS

110 modulation device
112 light source
114 modulated illumination device
116 enclosing tube
117 cylindrical wall
118 open end
120 closed end
122 inner space
124 incandescent lamp
126 inner wall
128 cylinder axis
130 driving system
132 motor
134 axle
136 rotation
138 aperture
140 movable segments
142 spectrometer device
144 sample
146 light
148 reflected light
150 housing
152 entrance window
154 wavelength-selective element
156 detector device
158 evaluation unit

### REFERENCES

US 2014/131578 A1
US 2005/0229698 A1
U.S. Pat. No. 3,394,253 A
EP 0 732 580 A2
U.S. Pat. No. 4,448,529 A
GB 814 072 A
U.S. Pat. No. 5,818,049 A
U.S. Pat. No. 3,417,253 A

1. A modulation device for periodically modulating light emitted by a light source, the modulation device comprising at least one enclosing tube being rotatable about a cylinder axis of the enclosing tube, the enclosing tube comprising at least one aperture disposed within a cylindrical wall of the enclosing tube, the modulation device further comprising at least one driving system for rotating the enclosing tube about the cylinder axis, wherein the at least one aperture is adjustable.

2. The modulation device according to claim 1, wherein the enclosing tube has an open end and a closed end, and wherein the driving system is coupled to the closed end of the enclosing tube.

3. The modulation device according to claim 2, wherein the driving system is coupled to the closed end by an axle disposed on the cylinder axis.

4. The modulation device according to claim 1, wherein the driving system comprises at least one electrical motor.

5. The modulation device according to claim 1, wherein the at least one aperture comprises at least one of: an opening disposed at a position spaced apart from both ends of the enclosing tube; a slot in a circumferential direction in the enclosing tube; and a slot in an axial direction of the enclosing tube.

6. The modulation device according to claim 1, wherein the aperture is fully or partially filled with at least one optically transparent material, and wherein the at least one optically transparent material is transparent in one or more of an ultraviolet spectral range, a visible spectral range or an infrared spectral range.

7. The modulation device according to claim 1, wherein the enclosing tube has a reflective coating on its inside.

8. The modulation device according to claim 1, wherein the at least one aperture is adjustable in at least one of size, position, width or length.

9. The modulation device according to claim 1, wherein the enclosing tube comprises at least one movable segment for adjusting the at least one aperture.

10. The modulation device according to claim 1, wherein the enclosing tube comprises at least two concentric partial tubes, each partial tube comprising at least one partial aperture, and wherein the at least one aperture of the enclosing tube is adjustable by one or both of turning or shifting the at least two concentric partial tubes relative to one another.

11. A modulated illumination device, comprising at least one modulation device according to claim 1, further comprising at least one light source disposed at least partially within the enclosing tube of the modulation device.

12. The modulated illumination device according to claim 11, wherein the at least one light source comprises an incandescent lamp.

13. A spectrometer device for optical analysis of at least one sample, the spectrometer device comprising at least one wavelength-selective element configured for separating incident light into a spectrum of constituent wavelengths, the spectrometer device further comprising at least one detector device configured for detecting at least a portion of the constituent wavelengths, and at least one modulated illumination device according to claim 11.

14. The spectrometer device according to claim 13, wherein the spectrometer device is a hand-held spectrometer device.

15. The spectrometer device according to claim 13, wherein the spectrometer device further comprises at least one evaluation unit, wherein the at least one evaluation unit is configured for driving the modulation device, and wherein the at least one evaluation unit is further configured for analyzing at least one detector signal provided by the detector device in a frequency-selective manner.

16. A method for periodically modulating light emitted by a light source, the method comprising:
i) providing the modulation device according to claim 1;
ii) providing at least one light source at least partially disposed within the enclosing tube of the modulation device;
iii) controlling the at least one light source to emit light; and
iv) rotating the enclosing tube about the cylinder axis.

17. A method of using the modulation device according to claim 1, the method comprising using the modulation device for a purpose of use selected from the group consisting of: an infrared detection application; a spectroscopy application; an exhaust gas monitoring application; a combustion process monitoring application; a pollution monitoring application; an industrial process monitoring application; a chemical process monitoring application; a food processing process monitoring application; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; a food analysis application; an agricultural application; a plant health monitoring application; a plastics identification and/or recycling application; a heat-detection application; a thermometer application; a heat-seeking application; a flame-detection application; a fire-detection application; a smoke-detection application; and a temperature sensing application.

18. The spectrometer device according to claim 13, wherein the spectrometer device further comprises at least one evaluation unit, wherein the at least one evaluation unit is configured for driving the modulation device, and wherein the at least one evaluation unit is further configured for analyzing at least one detector signal provided by the detector device by using a lock-in amplification.

19. The method of use according to claim 17, wherein the agricultural application is selected from the group consisting of characterization of soil, silage, feed, crop or produce.
